(19) United States
(12) Patent Application Publication
(10) Pub. No.: US 2013/0305053 A1
(43) Pub. Date: Nov. 14, 2013

(54) SYSTEMS, METHODS, AND APPARATUS TO AUTHENTICATE COMMUNICATIONS MODULES

(71) Applicant: Thomas M Laffey, Roseville, CA (US)

(72) Inventor: Thomas M Laffey, Roseville, CA (US)

(21) Appl. No.: 13/978,784

(22) PCT Filed: Feb. 10, 2011
(86) PCT No.: PCT/US11/24309

§ 371 Date: Jul. 9, 2013

(51) Int. Cl. H04L 9/32

(52) U.S. Cl. CPC H04L 9/3247
USPC 713/176

(57) ABSTRACT

In one implementation, a communications module includes a host interface, a communications link interface, a memory, and a processor operatively coupled to the host interface, to the communications link interface, and to the memory. The memory includes a signature based on a data set and a private key of a key pair. The processor provides the data set and the signature via the host interface.

### BACKGROUND

Communications modules are devices that provide communication between network devices. Typically, communications modules are modular and include a host interface and a communications link interface that operate using different standards, protocols, and/or physical signaling. In other words, communications modules can function as interchangeable intermediaries for communications links via which network devices are operatively coupled.

Because communications modules are often modular and, thus, interchangeable, counterfeit and/or compromised (e.g., altered) communications modules can be introduced into communications networks. Such counterfeit and/or compromised communications modules can affect the operation of the communications network (e.g., a counterfeit communications module can negatively impact data throughput in the communications network) and/or security of the communications network (e.g., a compromised communications module can divert data to unauthorized and/or unintended recipients).

### BRIEF DESCRIPTION OF THE DRAWINGS

FIG. 1 is a schematic block diagram of a communications network, according to an implementation.

FIG. 2 is a schematic block diagram of a communications module, according to an implementation.

FIG. 3 is a schematic block diagram of a communications module including a communications link, according to an implementation.

FIG. 4 is a schematic block diagram of a communications module host, according to an implementation.

FIG. 5 is a schematic block diagram of a communications module host and two communications modules, according to an implementation.

FIG. 6 is a communications flow diagram illustrating communication between a communications module host and a communications module, according to an implementation.

FIG. 7 is an illustration of data values stored at a memory of a communications module, according to an implementation.

FIG. 8 is a communications flow diagram illustrating communication between a communications module host and a communications module, according to an implementation.

FIG. 9 is a communications flow diagram illustrating communication between a communications module host and a communications module, according to an implementation.

FIG. 10 is an illustration of data values stored at a memory of a communications module, according to another implementation.

FIG. 11 is a flowchart of a process to authenticate a communications module, according to an implementation.

### DETAILED DESCRIPTION

Communications modules are devices via which network devices such as switch devices (e.g., network switches, routers, gateways, bridges, and hubs), computing devices (e.g., computer servers such as file, web, database or applications servers), and data stores (i.e., data storage devices and/or services) are operatively coupled one to another. As specific examples of communications modules, communications modules are receiver, transmitter, and/or transceiver modules such as Small Form Factor Pluggable (“SFP”) modules, Small Form Factor Pluggable Plus (“SFP+”) modules, 10 Gigabit Small Form Factor Pluggable (“XFP”) modules, and XENPAC modules.

Communications modules include a host interface that couples with a complementary communications module interface of a host (or local) network device via which the communications module and the host network device (or host) are in communication. Typically, the communications module and the host are removably coupled one to another via the host interface and the communications module interface. In some implementations, the host interface and communications module interface are hot-swappable (or hot-pluggable). Thus, a communications module can be coupled and/or removed from the host while the host is powered and/or operating.

Additionally, a communications module includes a communications link interface that couples to a communications link such as a twisted pair cable, a coaxial cable, a single-mode optical fiber, a multi-mode optical fiber, and/or a group of such communications links. The communications link is also coupled to a remote network device (i.e., a network device other than the host network device) and the communications module and the remote network device can communicate (e.g., send, receive, and/or exchange signals such as optical signals or electrical signals that represent data) one with another via the communications link. Said differently, the host can communicate with the remote network device via the communications module and the communications link. In some implementations, the remote network device includes a communications module via which the remote network device is coupled to the communications link (i.e., the remote network device is coupled to that communications module and that communications module is coupled to the communications link).

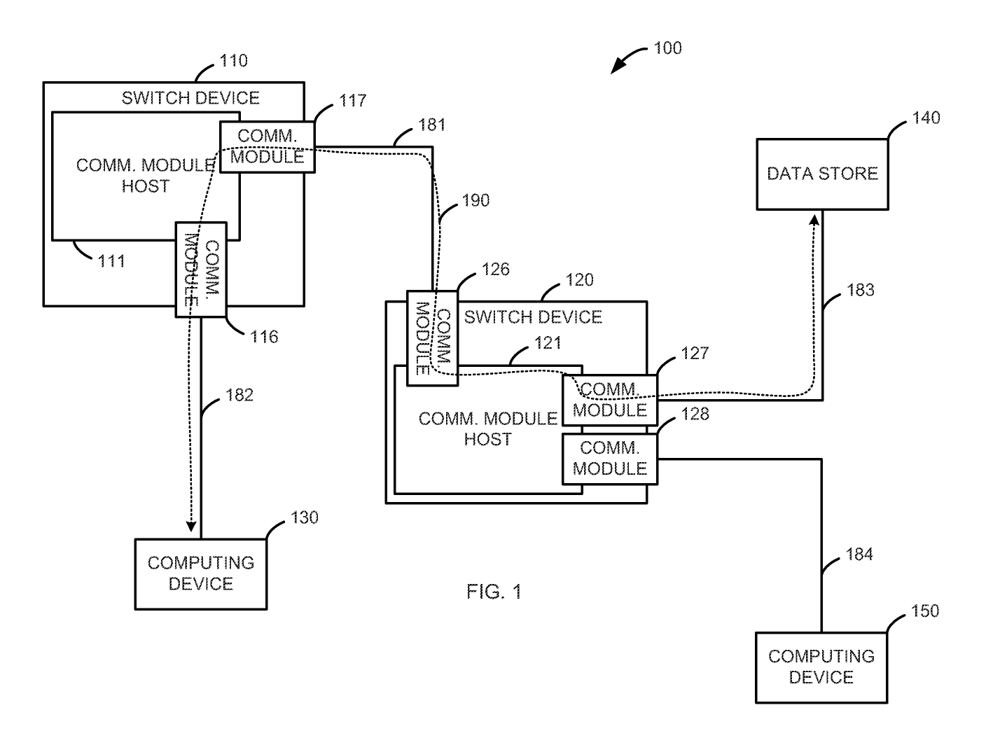

As an example, FIG. 1 is a schematic block diagram of communications network 100, according to an implementation. Communications network 100 includes switch device 110, switch device 120, computing device 130, computing device 140, and data store 150. Switch device 110 includes communications module host (labeled COMM. MODULE HOST) 111, communications module (labeled COMM. MODULE) 116, and communications module 117. Switch device 120 includes communications module host 121, communications module 126, communications module 127, and communications module 128.

Switch device 110 is operatively coupled to computing device 130 via communications link 182. More specifically, switch device 110 communicates with computing device 130 via communications module 116 and communications link 182. Similarly, switch device 120 is operatively coupled to data store 140 via communications link 183 and to computing device 150 via communications link 184. More specifically, switch device 120 communicates with data store 140 via communications module 127 and communications link 183, and with computing device 150 via communications module 128 and communications link 184. Additionally, switch device 110 and switch device 120 are operatively coupled one to another via communications link 181. More specifically, switch device 110 and switch device 120 communicate via communications module 117, communications link 181, and communications module 126.

Communications module hosts 111 and 121 are components or elements of switch devices 110 and 120, respectively, that include communications module interfaces at which communications modules 116 and 117 and 126, 127, and 128, respectively, are coupled (e.g., at host interfaces of those communications modules). In other words, communications module hosts 111 and 121 operate as intermediaries between switch device 110 and communications modules 116 and 117, and switch device 120 and communications modules 126, 127, and 128, respectively. That is, for example, switch device 110 provides data to and receives data from computing devices 130 via communications link 182, communications modules 116, and communications module host 111. As a specific example, switch devices 110 and 120 can be chasses within a datacenter and communications module hosts 111 and 121 can be network interface cards such as line cards of those chasses. In some implementations, a switch device does not include a separate communications module host, and the switch device itself can be referred to as a communications module host. That is, a communications module host is a component or device that hosts (e.g., provides operational power and/or control and/or data signals to) one or more communications modules.

Computing devices 130, 140, and 150 communicate one with other via the communications links to which they are coupled and switch devices 110 and 120. For example, path 190 illustrates a flow of data between computing device 130 and data store 140. Moreover, communication links 181, 182, 183, and 184 can be homogeneous or heterogeneous with respect to a mechanical connector, electrical connector, optical connector, type of signal supported, speed of signaling supported, and/or other properties of characteristics of communication links 181, 182, 183, and 184. For example, communication links 181, 182, 183, and 184 can each be optical fibers or can each be twisted pair cables. Alternatively, for example, communication link 181 can be a single-mode optical fiber, communication link 182 can be a multi-mode optical fiber, communication link 183 can be a twisted pair cable, and communication link 184 can be a coaxial cable.

Because communications modules are modular with respect to network devices (i.e., communications modules are separate or separable from the network devices to which they are coupled), communications modules can be sourced, procured, and/or replaced separate from those network devices and one another. This modularity can be particularly advantageous where the communications modules are expensive (e.g., due to expensive components such as opto-electrical, electro-optical, or processor components) and/or a network device should communicate with other network devices via various types of communications links.

For example, a network device (or communications module host) can include a group of communications module interfaces that conform to a common (i.e., the same) standard or protocol. A first communications module can have a host interface that conforms to that standard or protocol and a communications link interface that is, for example, compatible with a single-mode optical fiber (i.e., the first communications module can communicate via the single-mode optical fiber at the communications link interface). A second communications module can have a host interface that also conforms to that standard or protocol and a communications link interface that is, for example, compatible with a multi-mode optical fiber (i.e., the second communications module can communicate via the multimode-mode optical fiber at the communications link interface).

The network device can communicate via the single-mode optical fiber and via the multi-mode optical fiber without including single-mode or multi-mode optical interfaces, because the network device can communicate with the first communications module and the second communications module via the standard or protocol, the first communications module can communicate via the single-mode optical fiber, and the second communications module via the optical-mode optical fiber. Thus, the network device can be configured to communicate via various communications links (e.g., each based on different physical media, protocols, or standards) by coupling appropriate communications modules to the communications module interfaces of the network device.

Although the modularity of communications modules has many advantages, the ability to exchange or swap one communications module for another presents various challenges and security concerns. For example, counterfeit or compromised communications modules can be manufactured to store, intercept, relay, divert, and/or otherwise compromise data that traverse (i.e., are receive at and/or sent from) such communications modules. Genuine or trusted communications modules can be removed from a network device and replaced with these compromised communications modules with relative ease due to the modularity of communications modules. Moreover, communications modules that do not satisfy quality (e.g., speed, timing, operating conditions such as temperature or humidity) requirements or thresholds and/or are not sourced from a trusted party (e.g., a trusted manufacturer) can be counterfeited to appear to satisfy such requirements or to be from a trusted party. Furthermore, manually configuring a network device to communicate with only a specific communications device at a particular communications interface or with only a group of specific communications devices, for example, based on a serial number, unique identifier (e.g., a bit string, a byte string, or value), or device address (e.g., a medium access control (“MAC”) address), is tedious and time-consuming for system administrators and can be prone to errors.

Implementations discussed herein can authenticate communications modules based on information stored at those communications modules. For example, the communications modules can include a memory at which a data set (i.e., one or more data values) and a cryptographic signature (or signature) are stored. The cryptographic signature is defined by generating a digest (e.g., a hash value) of the data set and encrypting that digest with the private key of a key pair (i.e., a public key/private key pair). That is, the signature is based on the data set and the private key of the key pair. Because the public key/private key pair is used to generate the cryptographic signature for the communications module, that public key/private key pair can be referred to as associated with the communications module or as the public key/private key pair of the communications module.

To authenticate a communications module coupled to a host network device (e.g., via a communications module interface and host interface), that host network device requests the data set and the signature of that communications module. After receiving the data set and the signature, the host network device generates a digest of the data set using the same digest function (e.g., cryptographic hash function) as was used to generate the digest of the data set for the signature, and then decrypts the signature using the public key of the key pair. If the decrypted signature matches (e.g., is identical to) the digest generated by the host network device, the communications module can be considered authenticated (or authentic or trusted) by the host network device.

If the decrypted signature does not match the digest, the communications module can be classified as unauthenticated, not trusted, compromised (e.g., data values in the data set have been changed), and/or counterfeit, and the host network device can raise an error or failure condition (e.g., can store an entry in a log file, alter the status of an icon or image at a graphical user interface (“GUI”) used to monitor a communications network, or send an electronic mail (“email”) to a system administrator to indicate that a communications modules was not authenticated). Moreover, the host network device can disallow communication with that communications module. For example, the host network device can prevent an operational power (e.g., voltage) from reaching the communications module, can update a routing table to prevent data from being provided to that communications module, and/or otherwise prevent that communications module from receiving data.

As used herein, the singular forms “a,” “an,” and “the” include plural referents unless the context clearly dictates otherwise. Thus, for example, the term “communications link” is intended to mean one or more communications links or a combination of communications links. Additionally, as used herein, the term “module” refers to hardware, circuitry such as circuitry implementing computing logic, and/or software, firmware, programming, machine- or processor-readable instructions, commands, or code that are stored at a memory and executed or interpreted (or hosted) at a processor.

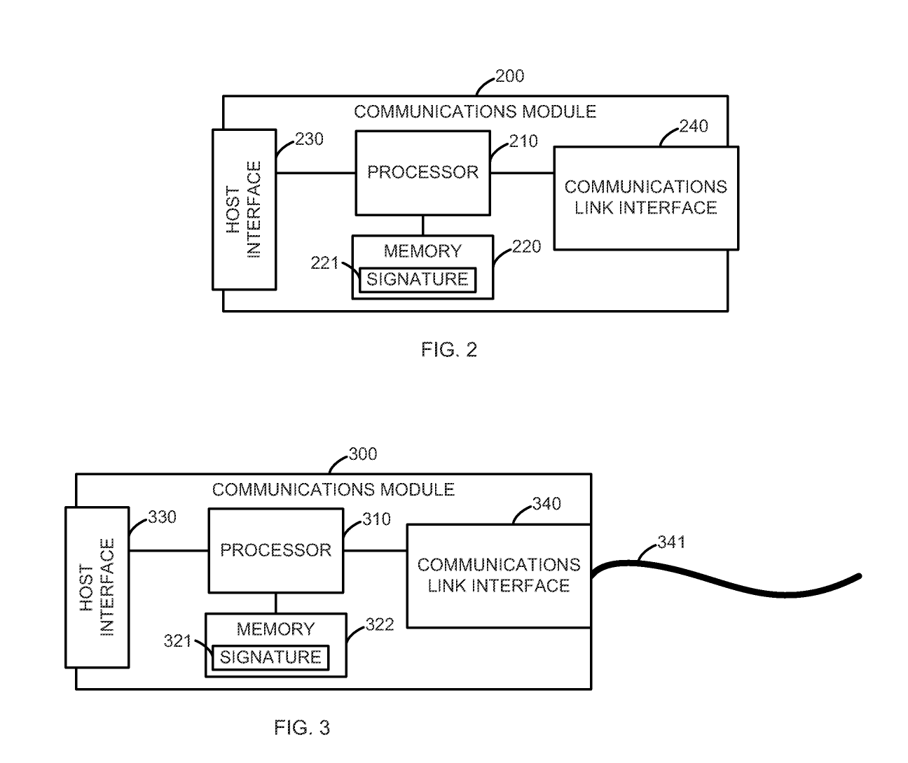

FIG. 2 is a schematic block diagram of a communications module, according to an implementation. Communications module 200 includes processor 210, memory 220, host interface 230, and communications link interface 240. Processor 210 is operatively coupled to memory 220, host interface 230, and communications link interface 240. As discussed above, host interface 230 and communications link interface 240 are interfaces that are adapted to couple to, mate with, or connect to a communications module host (e.g., via a communications module interface of the communications module host) and a communications link, respectively.

An interface is a component or group of components via which two or more devices (e.g., communications links, network devices, or communications modules) can be coupled one to another. That is, an interface can include a mechanical connector and/or modules such as signal conversion modules (e.g., opto-electrical converters and/or electro-optical converters) or signal conditioning modules (e.g., voltage level shifters) to allow two devices to exchange signals (e.g., optical signals or electrical signals) via the interface.

As aspecific example, host interface 230 can be an electrical interface and communications module host interface 240 can be an optical interface. That is, host interface 230 can include a connector that electrically and/or mechanically removably couples (i.e., is configured or adapted to be removably coupled) to a communications module host at a communications module interface and an electrical signal conditioning module. For example, the mechanical connector can form a compression fit, a friction fit, a snap fit, a magnetic coupling, and/or an annular lock with a communications module interface. More specifically, for example, the mechanical connector and communications module interface can each include features such as protrusions, ridges, flanges, indentations, magnets, electrically conductive contacts, electrically conductive pins or pads, electrically conductive receptacle, and/or other features via which the mechanical connector (and, thus, host interface 230) and communications module interface form a complementary fit one with another. Thus, processor 210 can communicate with the communications module host via host interface 230.

Communications link interface 240 can include a connector via which communications link interface 240 (or communications module 200) can be optically and/or mechanically removably coupled to a communications link. Similar to host interface 230, the mechanical connector can for a compression fit, a friction fit, a snap fit, a magnetic coupling, and/or an annular lock with a communications link (or a connector of a communications link). For example, the mechanical connector and a connector of a communications link can each include features such as protrusions, ridges, flanges, indentations, magnets, lenses, gratings, optical couplers, and/or other features via which the mechanical connector (and, thus, communications link interface 240) and a connector of a communications link form a complementary fit one with another. Additionally, communications link interface 240 can include an electro-optical conversion module to convert electrical signals received from processor 210 to optical signals and transmit those optical signals via an optical fiber coupled to the mechanical connector of communications link interface 240. Moreover, communications link interface 240 can include an opto-electrical conversion module to convert optical signals received via the optical fiber to electrical signals which are provided to processor 210.

Memory 220 includes code, instructions, and/or data values accessible to processor 210. Some data values stored at memory 220 are accessible by a communications module host at host interface 230. That is, the communications module host can request data values from processor 210 via host interface 230, and processor 210 can provide those data value to the communications module host via host interface 230. Moreover, the communications module host can provide data values from processor 210 via host interface 230, and processor 210 can update data values stored at memory 220 with those data values. For example, memory 220 can include operational values (or operational parameters) of communications module 200 such as values of gain, amplification, frequency, and/or other parameters of communications module 220.

Additionally memory 220 can include other data values such as a type or class identifier of communications module 200, an identifier of a manufacturer of communications module 200, a serial number of communications module 200, a unique identifier such as a MAC address of communications module 200, a description of communications module 200, and/or other data values related to communications module 200. Moreover, memory 220 includes (or stores) signature 221. In some implementations, memory 220 can include additional signatures and/or additional data values.

The memory locations at which these data values are stored at memory 220 can be referred to as registers of communications module 200. In other words, the data values stored at memory 220 are accessible at (or can be addressed relative to) registers of communications module 200. Therefore, a communications module host can access (e.g., read and/or write) these data values via host interface 230 at registers of communications module 200. For example, the communications module host can request access to data values at registers of communications module 200 by providing an access request or signal (e.g., a request to read or write a data value included in the access request) to processor 210 via host interface 230. Furthermore, communications module 200 can include other memories such as a memory integrated at processor 210 that includes registers accessible via host interface 230. Thus, the registers of communications module 200 can be memory locations at multiple memories.

Signature 221 is a data value that can be accessed via host interface 230 to authenticate communications module 200. That is, signature 221 can be used to determine whether communications module 200 and/or a data set (i.e., one or more data values) stored at communications module 200 is authentic, can be trusted, is valid, and/or is unchanged from a previous state or condition. As an example, signature 221 can be an encrypted digest of a data set stored at registers of communications module 200. That is, the data values at registers of communications module 200 can be processed and the result of that processing can be encrypted with an encryption key.

As a specific example, a data set including data values at various registers of communications module 200 can be provided to a hash function such as a cyclic redundancy check or a cryptographic hash function (e.g., a SHA1 hash function, a SHA256 hash function, and MD4 hash function, and/or an MD5 hash function). The hash value output from the hash function is the digest (or digest value) of the data set. The digest is then encrypted with the private key of a key pair of an asymmetric cryptographic system (i.e., a cryptographic system using asymmetric encryption based on an asymmetric cipher or algorithm). In other words, the signature is signed with the private key.

Because the signature is signed with the private key of the key pair, the public key of the key pair can be openly distributed for use at communications module hosts. That is, in an asymmetric cryptographic system (e.g., an elliptic curve cryptographic system, an RSA (“Rivest, Shamir and Adleman”) cryptographic system, or an ElGamal cryptographic system), a data set encrypted with the private key of a key pair is decrypted with the public key of the key pair. Similarly, a data set encrypted with the public key of a key pair is decrypted with the private key of the key pair. In other words, one key of the key pair reverses the operation on the data set of the other key of the key pair. Thus, the relationship between a private key and a public key of a key pair as discussed herein is relative. One key (or subset of keys) of the key pair, by convention referred to as the private key, is not distributed beyond those parties (or signers) that are authorized to sign data sets for the owner or holder of the key pair. The other key (or subset of keys) of the key pair, by convention referred to as the public key, is distributed to allow parties to decrypt data sets encrypted by the signers. Accordingly, here, the private key should be kept confidential to prevent counterfeits of communications module 200, but the public key can be openly distributed.

If a counterfeiter attempts to produce a counterfeit communications module (e.g., by using the public key associated with (of the same key pair) the private key used to sign signature 221 or a key from a different key pair)that appears to be communications module 200, a communications module host attempting to authenticate a counterfeit communications module will use the public key of the key pair associated communications module 200 to decrypt the signature. This will generate a value that does not match the digest of the data set of the counterfeit communications module. Accordingly, the communications module host can determine that the counterfeit communications module was not authenticated.

Typically, signature 221 is generated and stored at memory 220 during manufacturing of communications module 200 by the manufacturer or a party on behalf of whom the manufacturer is manufacturing communications module 200. Said differently, the signer of the signature (i.e., the party that encrypts the digest with the private key) is a party authorized to use the private key or to whom the private key was issued. Because the private key need not be distributed to allow communications module hosts to authenticate communications module 200, the signer of the signature can have a single copy or a controlled set of copies of the private key.

Processor 210 facilitates exchange of data (e.g., signals representing data) between host interface 230 and communications link 240. In some implementations, communications module 200 includes an additional processor such as an application specific integrated circuit (“ASIC”) or field-programmable gate array (“FPGA”) to facilitate exchange of data between host interface 230 and communications link 240.

Moreover, processor 210 provides authentication information related to communications module 200 to a communications module host. That is, processor 210 can provide data values from registers of communications modules 200 and signature 221 to a communications module host in response to a request for authentication information via host interface 230. The communications module host can process this information to authenticate communications module 200. In other words, processor 210 is not required to perform cryptographic operations or process and provide responses to challenges issued by the communications module host, rather the communications module host performs the authentication operations based on the information provided by communications module 200. Thus, processor 210 need not execute cryptographic routines, functions, or operations for communications module 200 to be authenticated by the communications module host.

FIG. 3 is a schematic block diagram of a communications module including a communications link, according to an implementation. Communications module 300 includes processor 310, memory 320, host interface 330, and communications link interface 340, which are similar to processor 210, memory 220, host interface 230, and communications link interface 240, respectively, discussed above in relation to FIG. 2. Memory 320 includes signature 321, which is similar to signature 221 discussed above in relation to FIG. 2.

Communications link 341 is integrated with communications module 300 and is coupled to communications link interface 340. In other words, communications link 341 is permanently (or non-removably) coupled to communications module 300. Said differently, communications module 300 is an endpoint or terminus of communications link 341. Thus, rather than communications link interface 340 being removably coupleable to a communications link (as communications link interface 240 discussed above in relation to FIG. 2), communications link interface 340 is permanently connected to communications link 341.

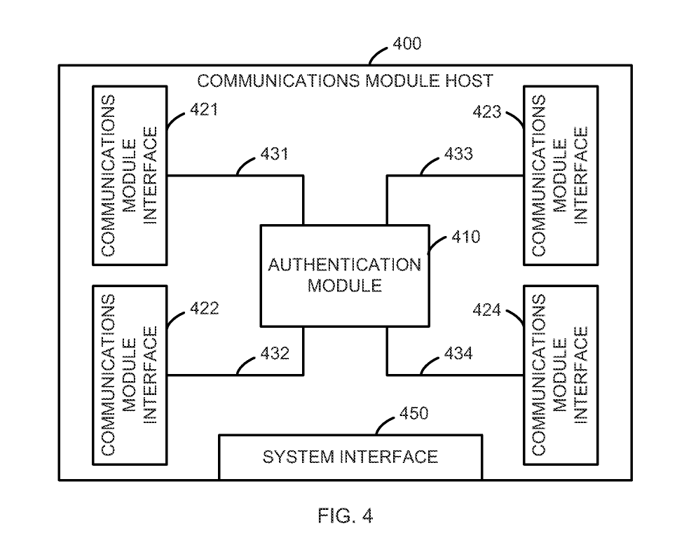

FIG. 4 is a schematic block diagram of a communications module host, according to an implementation. Communications module host 400 includes authentication module 410, communications module interfaces 421, 422, 423, and 434, system interface 450, and links 431, 432, 433, and 434. Communications module host 400 can also include an additional processor (not shown) that is operatively coupled to system interface 450 and communications module interfaces 421, 422, 423, and 424, for example, to exchange data (e.g., data packets in a packet switching network) between system interface 450 and communications module interfaces 421, 422, 423, and 424.

Authentication module 410 is operatively coupled to communications module interfaces 421, 422, 423, and 434 via links 431, 432, 433, and 434. Communications module interfaces 421, 422, 423, and 424 are complementary to host interfaces of communications modules. That is, communications module interfaces 421, 422, 423, and 424 form a complementary fit with host interfaces of communications modules. Moreover, communications module host 400 exchanges signals representing data with communications modules via communications module interfaces 421, 422, 423, and 424. For example, data can be received at system interface 450 (i.e., a connection to a backplane of a chassis) and transmitted via one or more of communications module interfaces 421, 422, 423, and 424.

Links 431, 432, 433, and 434 allow signals to be exchanged between authentication module 410 and communications module interfaces 421, 422, 423, and 424 (or communications module operatively coupled to communications module interfaces 421, 422, 423, and 424). For example, links 431, 432, 433, and 434 can be electrically conductive traces at a circuit board, optical paths in a substrate, cables, fibers, and/or other links.

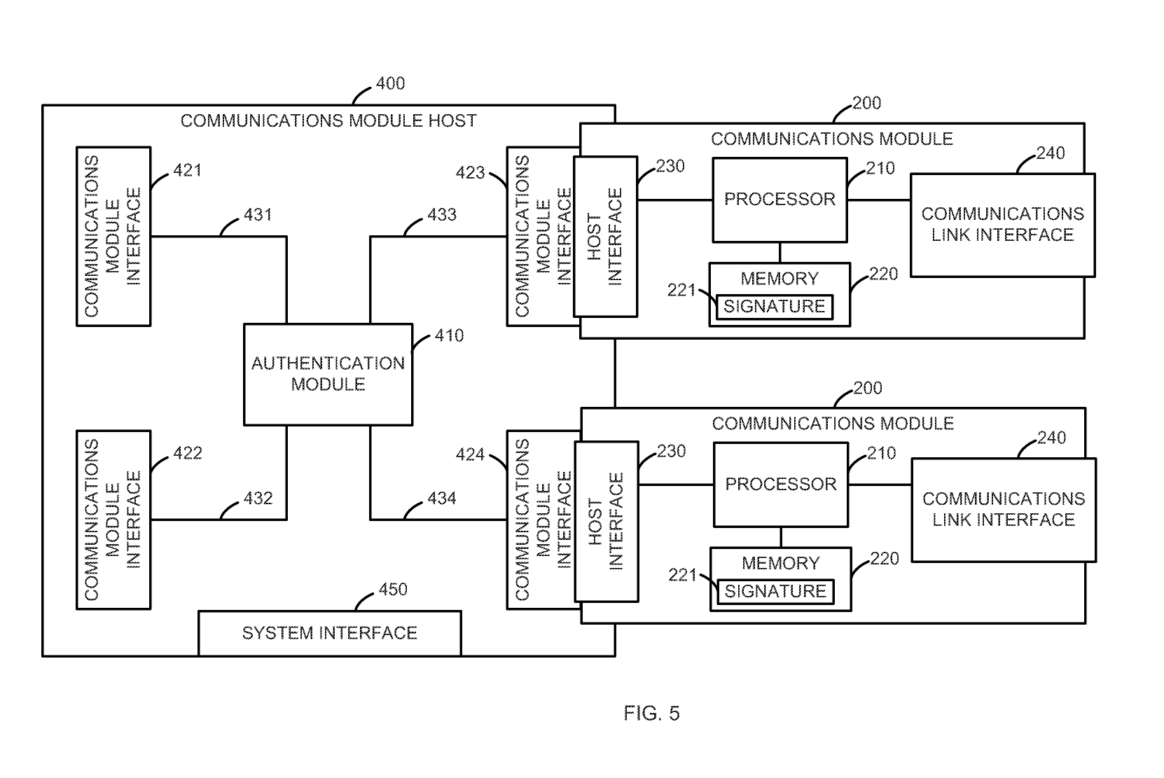

Authentication module 410 communicates with communications modules to authenticate communications modules operatively coupled to (or at) communications module interfaces 421, 422, 423, and 424. For example, FIG. 5 is a schematic block diagram of communications module host 400 and two communications modules 200, according to an implementation. Authentication module 410 receives data sets and signatures from communications modules 200 at communications module interfaces 423 and 424 and authenticates those communications modules by verifying the signatures using the data sets and public keys associated with those signatures or communications modules (i.e., the public keys of key pairs including the private keys used to sign those signatures). Moreover, authentication module 410 can access or request data sets and signatures from communications modules at communications module interfaces 421 and 422 and authenticate those communications modules by verifying the signatures using the data sets and public keys associated with those signatures or communications modules after communications modules are coupled or connected to communications module interfaces 421 and 422.

For example, communications module host 400 can include a memory (not shown) at which public keys are stored and each communications module at communications module interfaces 421, 422, 423, and 424 can provide an identifier of the key pair having the private key used to generate the signature provided by that communications module. Authentication module 410 can use these identifiers to access the appropriate public key to decrypt the signatures, and authenticate the communications modules based on digests generated from the data sets received from each communications module at communications module interfaces 421, 422, 423, and 424. Alternatively, if a public key identified by such an identifier is not already available at communications module host 400, communications module host 400 can first request that public key at, for example, a key distribution service via system interface 450 or via one of communications module interfaces 421, 422, 423, and 424 and authenticate the communications module that provided that identifier after the public key is received.

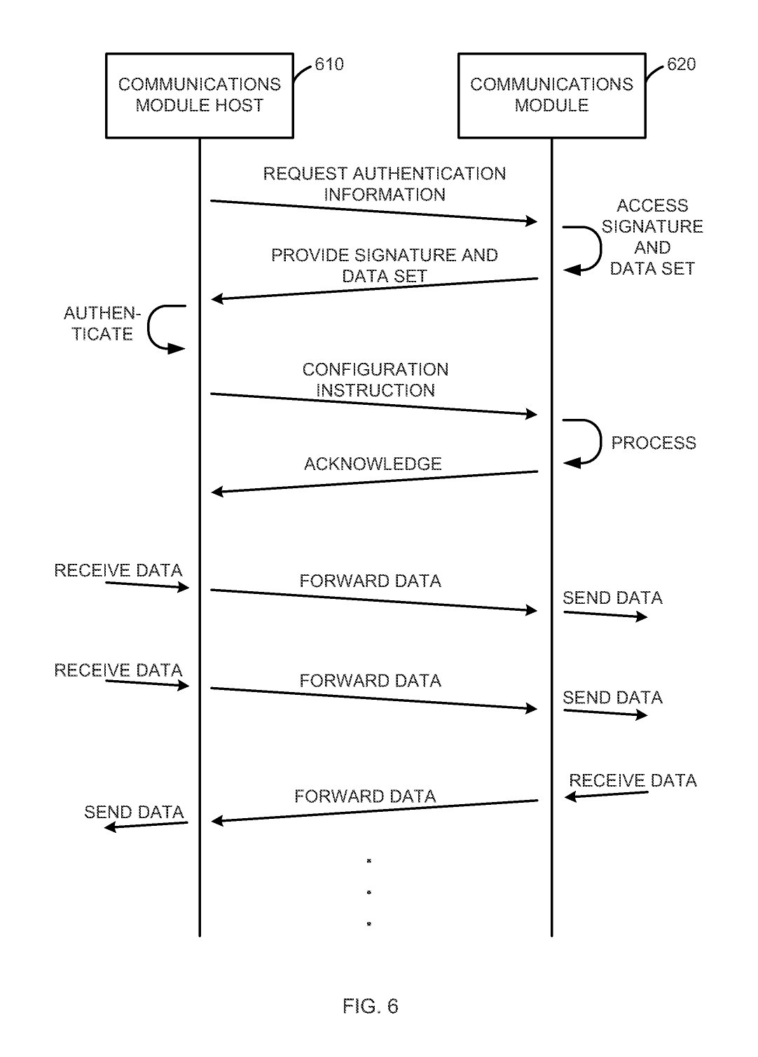

FIG. 6 is a communications flow diagram illustrating communication between communications module host 610 and communications module 620, according to an implementation. Communications module host 610 detects that communications module 620 is coupled to communications module host 610 (e.g., based on a signal from communications module 620 or a signal from a communications module interface to which communications module 620 is coupled) and requests (i.e., provides a request for) authentication information from communications module 620. The requests for authentication module can be a single request for authentication information (e.g., for a signature, a data set, an identifier of the key pair having the private key used to sign the signature, and/or other information), or communications module host 610 can request the authentication information separately. That is, communications module host 610 can separately request each of a signature, a data set, and/or an identifier of the key pair having the private key used to sign the signature.

Moreover, the requests for authentication information (and other data or information) can be provided using various methodologies. For example, a request for authentication information can be provided by sending the request via a communications channel such as an Inter-Integrated Circuit (“IIC”, “I2C”, or “I²C”), Serial Peripheral Interconnect (“SPI”), or parallel bus communications channel. Alternatively, for example, a request for authentication information can be provided by storing the request (or other data) at a location, such as a register or mailbox of a communications module or other device, at which the request (or other data) can be accessed by the device to which the request was provided. In some implementations, a signal such as an interrupt signal can also be provided to a device to indicate that a request (or other data) is stored at that location.

Communications module 620 receives the request for authentication information and accesses that information at, for example, registers of communications module 620. For example, as illustrated in FIG. 6, communications module 620 accesses a signature and a data set and provides the signature and the data set to communications module host 610. As discussed above, the signature is an encrypted digest of the data set, and the data set can include data values stored at registers of communications module 620.

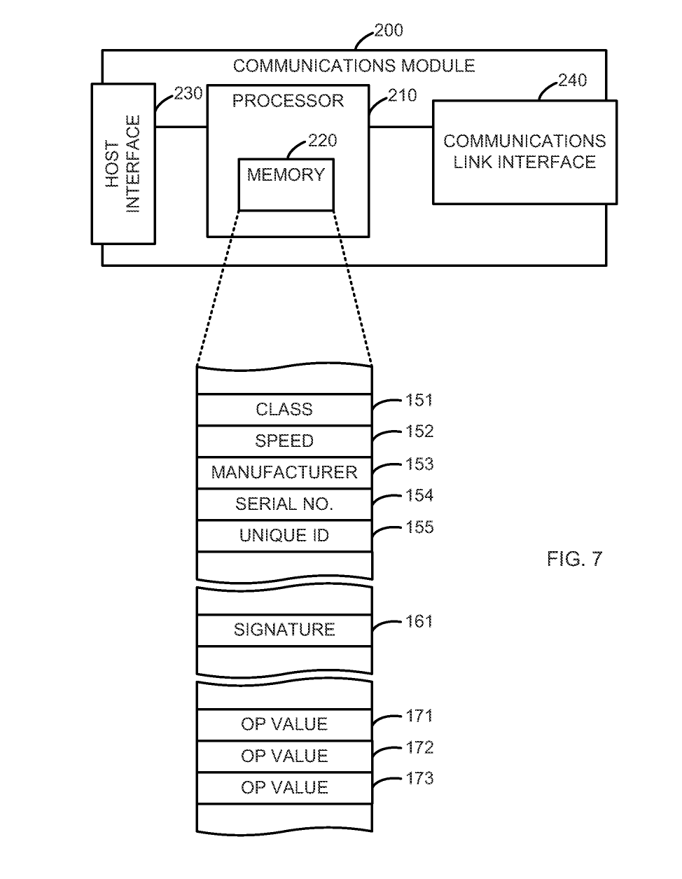

As a specific example, FIG. 7 is an illustration of data values stored at a memory of a communications module, according to an implementation. Communications module 200 is similar to communications modules discussed above, for example, in relation to FIG. 2, and includes memory 220 integrated at processor 210. Moreover, communications module 200 includes registers 151, 152, 153, 154, 155, 161, 171, 172, and 173. As discussed above, registers 151, 152, 153, 154, 155, 161, 171, 172, and 173 represent memory locations of memory 220 and store data values.

More specifically, in the example illustrated in FIG. 7, registers 151, 152, 153, 154, 155, 161, 171, 172, and 173 include an identifier of a class of communications module 200, an identifier of a speed of communications module 200, an identifier of a manufacturer of communications module 200, a serial number (labeled “SERIAL NO.”) of communications module 200, a unique identifier (e.g., a globally unique identifier, a MAC address, or an identifier that is unique to communications module 200 for a manufacturer; labeled “UNIQUE ID”) of communications module 200 (or of a component such as a processor or interface of communications module 200), a signature of communications module 200, and operational values (labeled “OP VALUE”) of communications module 200, respectively. Operational values accessible at registers 171, 172, and 173 can be values such as an identifier of an operational state of communications module 200, a value of an amplification parameter of an electro-optical conversion module of communications module 200, and/or some other value of a parameter. Furthermore, communications module 200 can include registers in addition to those illustrated in FIG. 7. For example, communications module 200 can include a register storing an identifier of the key pair having the private key used to sign the signature.

A data set requested by a communications module host can include one or more of the data values at registers 151, 152, 153, 154, 155, 171, 172, and 173. For example, the data set requested by and provided to a communications module host can include the data values at registers 153, 154, and 155 (e.g., the manufacturer identifier, the serial number, and the unique identifier). The signature stored at register 161 is the encrypted digest of the data set provided to the communications module host.

As illustrated in FIG. 7, memory 220 does not include the public key of the key pair having the private key used to encrypt the digest of the data set to generate the signature stored at register 161. That is, as illustrated in FIG. 7, communications module 200 does not include a public key to decrypt the signature stored at register 161. Thus, a communications module host that has received the signature stored at register 161 from communications module 200 accesses the public key from another resource or service such as a key distribution service. In other implementations, memory 220 includes a public key to decrypt the signature stored at register 161 and a communications module host can access that public key via host interface 230 and/or processor 210.

Referring to FIG. 6, in some implementations, the data set can include a data value generated based on data values, codes, or instructions accessible at communications module 620. For example, the data set can include a digest (e.g., hash value) of a firmware image of communications module 620.

Communications module host 610 authenticates communications module 620 based on the authentication information provided by communications module 620. As illustrated in FIG. 6, communications module host 610 generates a digest based on the data set and decrypts the signature using a public key of the key pair having the private key used to sign the signature.

The public key used to decrypt the signature is typically provided to communications module host 610 out-of-band with respect to the communication flow illustrated in FIG. 6. For example, that public key was provided to communications module 610 before communications module 610 requested the authentication information. In other implementations, communications module host 610 can request (not illustrated) the public key from a key distribution service during the communications flow illustrated in FIG. 6. In yet other implementations, communications module 620 can provide the public key to communications module host 610.

If the digest and the decrypted signature match (e.g., have the same value), communications module host 610 determines that communications module 620 is authenticated and further communicates with communications module 620. As illustrated in FIG. 6, communications module 610 provides a configuration instruction to communications module 620 (e.g., an activate command or a data value of a register associated with a power output of an electro-optical conversion module of communications module 620), communications module 620 processes (or executes) that instruction, and communications module 620 acknowledges the configuration instruction to communications module host 610.

Data are then received at communications module host 610 and communications module 620, forwarded to communications module 620 and communications module host 610, respectively, and sent from communications module host 610 and communications module 620. That is, communications module host 610 receives data from, for example, a system interface or communications module interface of communications module host 610, forwards those data to communications module 620, and communications module 620 then sends those data via a communications link operatively coupled to communications module 620 (e.g., via a communications link interface of communications module 620). Additionally, communications module 620 receives data (e.g., via a communications link) and forwards those data to communications module 610 (e.g., via a host interface and communications module interface). Communications module 610 then sends those data to other devices via a system interface or communications module interfaces of communications module 610.

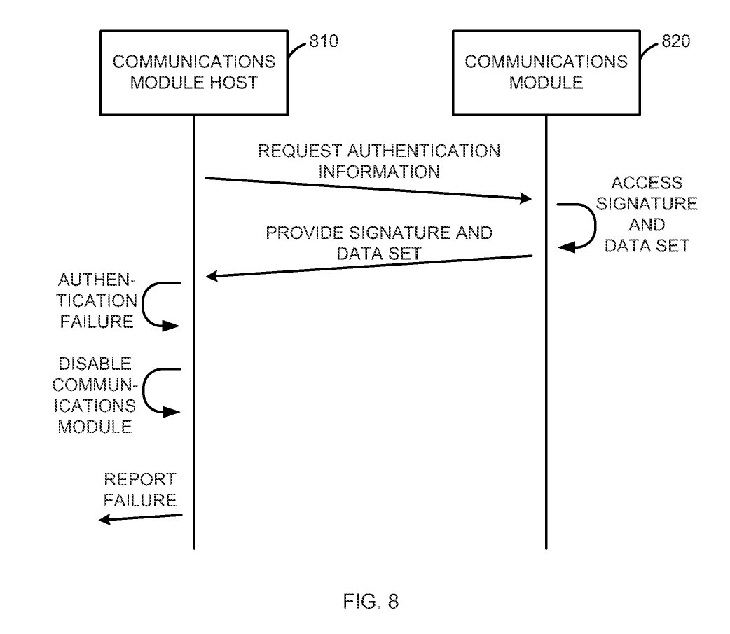

FIG. 8 is a communications flow diagram illustrating communication between communications module host 810 and communications module 820, according to an implementation. Communications module host 810 detects that communications module 820 is coupled to communications module host 810 and requests authentication information from communications module 820.

Communications module 820 receives the request for authentication information and accesses that information at, for example, registers of communications module 820. For example, as illustrated in FIG. 8, communications module 820 accesses a signature and a data set and provides the signature and the data set to communications module host 810. As discussed above, the signature is an encrypted digest of the data set, and the data set can include data values stored at registers of communications module 820.

Communications module host 810 authenticates communications module 820 based on the authentication information provided by communications module 820. For example, communications module host 810 generates a digest based on the data set and decrypts the signature using a public key of the key pair having the private key used to sign the signature.

As illustrated in FIG. 8, if the digest and the decrypted signature do not match, communications module host 810 disables (or prevents or inhibits) communication at communications module 820. For example, communications module host 810 can disable (e.g., inhibit operational power to) the communications module interface to which communications module 820 is operatively coupled. Alternatively, communications module host 810 can disconnect links to that communications module interface.

Communications module host 810 then reports the failed authentication. For example, communications module host 810 can store an entry in a log file, alter the status of an icon or image at a GUI used to monitor a communications network, or send an email to a system administrator to indicate that a communications modules was not authenticated.

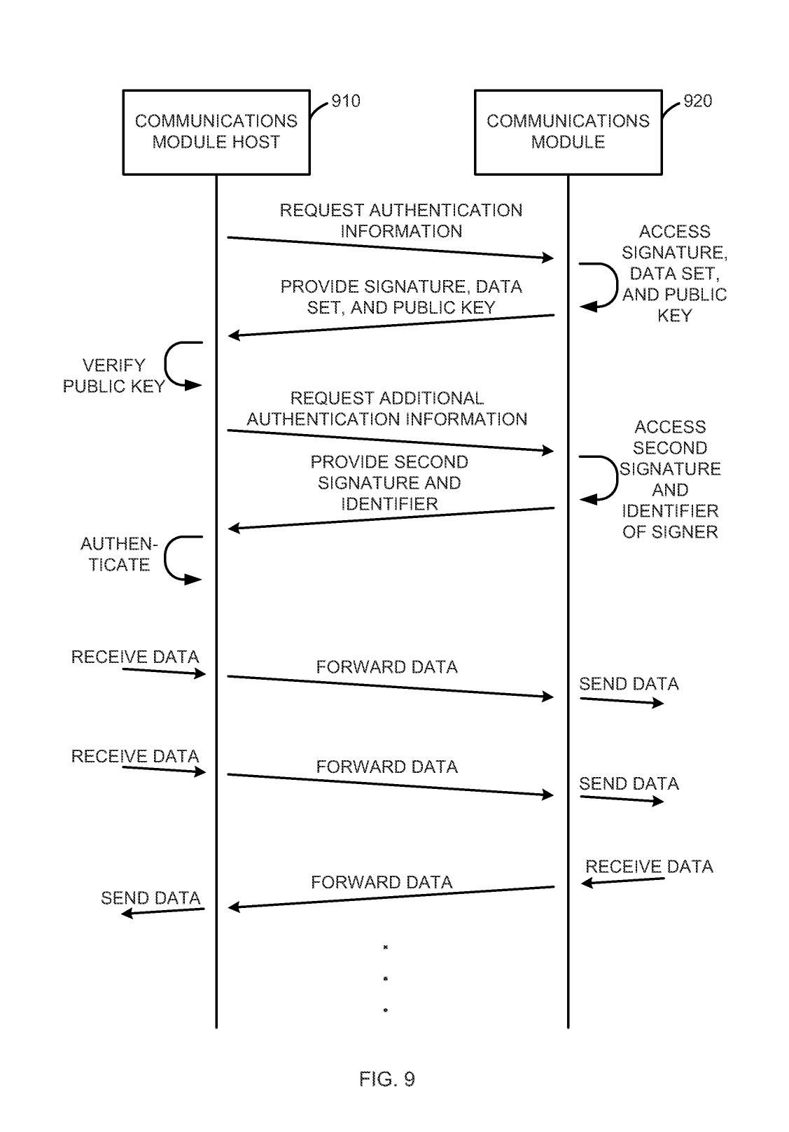

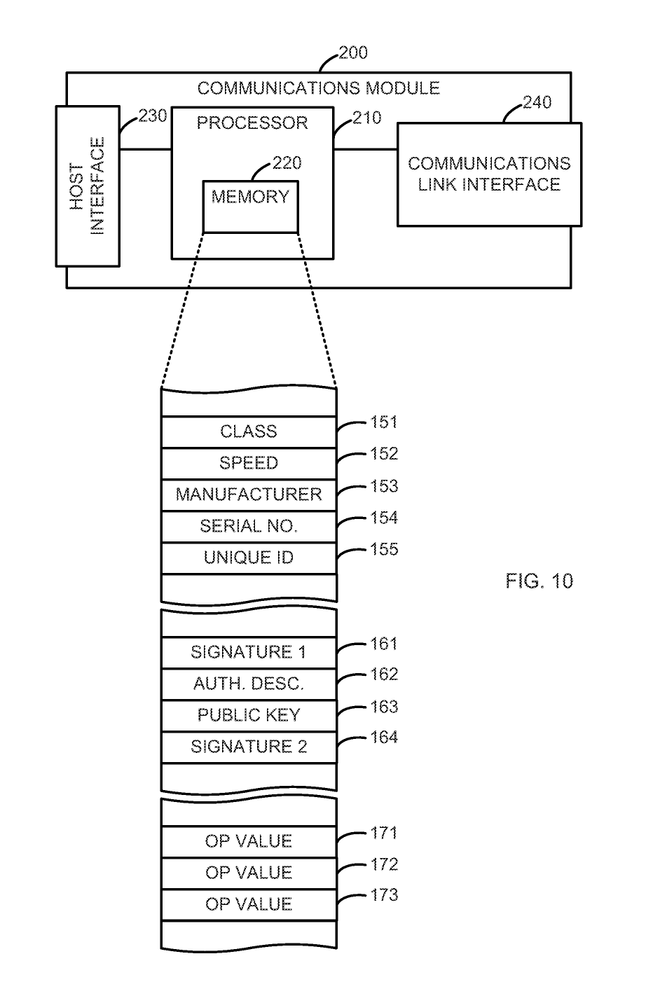

FIG. 9 is a communications flow diagram illustrating communication between communications module host 910 and communications module 920, according to an implementation. Communications module host 910 detects that communications module 920 is coupled to communications module host 910 and requests authentication information from communications module 920. The requests for authentication module can be a single request for authentication information, or communications module host 910 can request the authentication information separately. That is, communications module host 910 can separately request each of a first signature, a data set, a public key, and an identifier of the key pair having the private key used to sign the first signature.

Communications module 920 receives the request for authentication information and accesses that information at, for example, registers of communications module 920. For example, as illustrated in FIG. 9, communications module 920 accesses a first signature, a data set, and a public key, and provides the first signature, the data set, and the public key to communications module host 910.

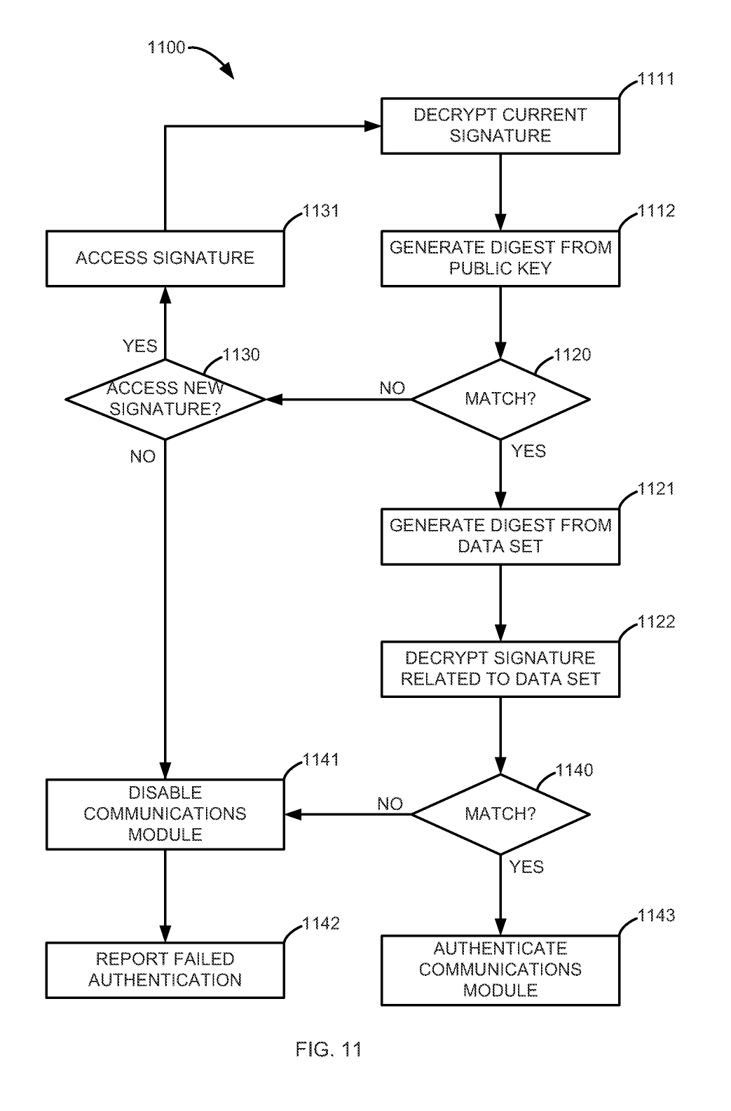

As a specific example, FIG. 10 is an illustration of data values stored at a memory of a communications module, according to an implementation. Communications module 200 is similar to communications modules discussed above, for example, in relation to FIG. 2, and includes memory 220 integrated at processor 210. Moreover, communications module 200 includes registers 151, 152, 153, 154, 155, 161, 162, 163, 171, 172, and 173. As discussed above, registers 151, 152, 153, 154, 155, 161, 162, 163, 171, 172, and 173 represent memory locations of memory 220 and store data values.

More specifically, in the example illustrated in FIG. 10, registers 151, 152, 153, 154, 155, 161, 162, 163, 171, 172, and 173 include an identifier of a class of communications module 200, an identifier of a speed of communications module 200, an identifier of a manufacturer of communications module 200, a serial number (labeled “SERIAL NO.”) of communications module 200, a unique identifier (e.g., a globally unique identifier, a MAC address, or an identifier that is unique to communications module 200 for a manufacturer; labeled “UNIQUE ID”) of communications module 200, a first signature of communications module 200, a public key associated with communications module 200 (e.g., the public key of the key pair having the private key used to sign the first signature at register 161), a second signature of communications module 200, and operational values (labeled “OP VALUE”) of communications module 200, respectively. Furthermore, communications module 200 can include registers in addition to those illustrated in FIG. 10. For example, communications module 200 can include a register storing an identifier of the key pair having the private key used to sign the first signature and/or the second signature.

A data set requested by a communications module host can include one or more of the data values at registers 151, 152, 153, 154, 155, 171, 172, and 173. For example, the data set requested by and provided to a communications module host can include the data values at registers 151, 152, and 155 (e.g., the class identifier, the speed number, and the unique identifier).

The second signature is an encrypted hash of information that identifies and/or authenticates the public key of the key pair having the private key used to sign the first signature. That is, the first signature is an encrypted digest of a data set of communications module 200, and the second signature authenticates the public key used to decrypt the first signature or other information that authenticates that public key. As a specific example, the second signature can be an encrypted digest based on the public key of the key pair having the private key used to generate the first signature and an identifier of the signer of the second signature. The second signature is signed (i.e., encrypted) with a private key of a key pair that is different from the key pair having the private key used to sign the first signature (i.e., the first signature and the second signature are signed with different private keys). In some implementations, communications module 200 also includes a register storing an identifier of the signer of the second signature.

Furthermore, communications module 200 can include a third signature, a fourth signature, and/or other signatures to further authenticate public keys used to decrypt each signature. That is, similar to a public key infrastructure (“PKI”) cryptographic system, a hierarchy of signatures (e.g., a chain or web of trust) can exist in which each signature is authenticates a public key (or the identify of a signer of another signature) and is encrypted using a private key of a key pair different from the key pair including the public key that signature authenticates. Such a hierarchy of signature is discussed in more detail below in relation to FIG. 9.

Referring to FIG. 9, in some implementations, the data set can include a data value generated based on data values, codes, or instructions accessible at communications module 920. For example, the data set can include a digest (e.g., hash value) of a firmware image of communications module 920.

Communications module host 910 authenticates communications module 920 based on the authentication information provided by communications module 920. As illustrated in FIG. 9, communications module host 910 verifies the public key by requesting additional authentication information from communications module 920. Communications module 920 receives the request for additional authentication information and accesses a second signature and an identifier of the signer of the second signature. Communications module 920 then provides the second signature and identifier of the signer of the second signature to communications module host 910.

After receiving the second signature and identifier of the signer of the second signature, communications module host 910 authenticates communications module 920, for example, as illustrated in FIG. 11. FIG. 11 is a flowchart of a process to authenticate a communications module, according to an implementation. Process 1100 can be implemented as a hardware module, as a software module hosted at a computing device, and/or as a combination of a hardware module and a software module. For example, process 1100 can be implemented as application-specific circuitry or as a software module including instructions stored at a memory and executed at a processor in communication with the memory. More specifically, for example, process 1100 can be implemented at a communications module host.

Referring to communications module host 910 as an example of a communications module host implementing process 1100, communications module host 910 authenticates communications module 920 by first authenticating the public key of the key pair having the private key used to sign the first signature (i.e., the public key received from communications module 920) using the second signature and then authenticating the first signature. More specifically, at block 1111, communications module host 910 decrypts the current (here, second) signature by accessing (e.g., locally or remotely from a key distribution service) a public key of a key pair having the private key used to encrypt the second signature based the identifier of the signer of the second signature. Communications module host 910 then uses that public key to decrypt the second signature, which is an encrypted digest of the public key received from communications module 920 and an identifier of the signer of the second signature, at block 1111.

Communications module 910 then generates a digest of the public key and the identifier of the signer of the second signature received from communications module 920 at block 1112, and compares that digest with the unencrypted second signature at block 1120. If the values of the digest and the unencrypted second signature do not match at block 1120, communications module host 910 determines whether a new or different signature should be accessed to authenticate the public key received from communications module 920. If communications module host 910 determines that a different signature should not be accessed (e.g., based on a policy such as a security policy or setting of communications module host 910), communications module host 910 can proceed to block 1141 to disable communications module 920 and report an authentication failure at block 1142, for example, as discussed above.

Alternatively, for example, communications module 910 can determine that a new signature should be requested at block 1130, and access that signature (e.g., request yet additional authentication information such as a third signature that can authenticate the public key received from communications module 920 or from a signature distribution service) at block 1131. Communications module host 910 then proceeds to block 1111 to attempt to authenticate the public key received from communications module 920 using the new (now current) signature.

Referring to block 1120, if the values of the digest generated at block 1112 and the unencrypted second signature decrypted at block 1111 match, communications module host 910 has authenticated the public key received from communications module 920 using the second (or a subsequent) signature and proceeds to authenticate communications module 920. More specifically, for example, communications module host 910 generates a digest based on the data set at block 1121 and decrypts the first signature using the public key received from communications module 920 at block 1122. If the digest and the decrypted signature do not match at block 1140, communications module host 910 proceeds to disable communications module 920 (or communication at communications module 920) at block 1141 and/or report the authentication failure at block 1142, for example as discussed above. If the digest and the decrypted signature match (e.g., have the same value) at block 1140, communications module host 910 determines that communications module 920 is authenticated at block 1143 and further communicates with communications module 920.

Process 1100 can include additional or fewer blocks than those illustrated in FIG. 11. For example, in some implementations, process 1100 includes blocks at which the signature (or a public key of a key pair having the private key used to sign that signature) that is used to authenticate the public key (e.g., the public key received from communications module 920 in FIG. 9) that decrypts the signature used to authenticate a communications module is authenticated by yet another signature similarly to authentication of the public key. Thus, there can be a hierarchy of more than two signatures that are authenticated to authenticate a public key used to decrypt a signature used to authenticate a communications module. Furthermore, although process 1100 is discussed above in relation to a particular environment including communications module host 910 and communications module 920, process 1100 can be applicable to other environments.

Referring again to FIG. 9 as an example, after communications module host 910 has authenticated communications module 920, data are received at communications module host 910 and communications module 920, forwarded to communications module 920 and communications module host 910, respectively, and sent from communications module host 910 and communications module 920. That is, communications module host 910 receives data from, for example, a system interface or communications module interface of communications module host 910, forwards those data to communications module 920, and communications module 920 then sends those data via a communications link operatively coupled to communications module 920 (e.g., via a communications link interface of communications module 920). Additionally, communications module 920 receives data (e.g., via a communications link) and forwards those data to communications module 910 (e.g., via a host interface and communications module interface). Communications module 910 then sends those data to other devices via a system interface or communications module interfaces of communications module 910.

Some implementations include a processor and a related processor-readable medium having instructions or computer code thereon for performing various processor-implemented operations. Such a processor can be a general-purpose processor or an application-specific process and can be implemented as a hardware module and/or a software module. A hardware module can be, for example, a microprocessor, a microcontroller, an application-specific integrated circuit (“ASIC”), a programmable logic device (“PLD”) such as a field programmable gate array (“FPGA”), and/or other electronic circuits that perform operations. A software module can be, for example, instructions, commands, and/or codes stored at a memory and executed at another processor. Such a software module can be defined using one or more programming languages such as Java™, C++, C, an assembly language, a hardware description language, and/or another suitable programming language. For example, a processor can be a virtual machine hosted at a computer server including a microprocessor and a memory.

In some implementations, a processor can include multiple processors. For example, a processor can be a microprocessor including multiple processing engines (e.g., computation, algorithmic or thread cores). As another example, a processor can be a computing device including multiple processors with a shared clock, memory bus, input/output bus, and/or other shared resources. Furthermore, a processor can be a distributed processor. For example, a processor can include multiple computing devices, each including a processor, in communication one with another via a communications link such as a computer network.

Examples of processor-readable media include, but are not limited to: magnetic storage media such as a hard disk, a floppy disk, and/or magnetic tape; optical storage media such as a compact disc (“CD”), a digital video disc (“DVDs”), a compact disc read-only memory (“CD-ROM”), and/or a holographic device; magneto-optical storage media; non-volatile memory such as read-only memory (“ROM”), programmable read-only memory (“PROM”), erasable programmable read-only memory (“EPROM”), electronically erasable read-only memory (“EEPROM”), and/or FLASH memory; and random-access memory (“RAM”). Examples of computer code include, but are not limited to, micro-code or micro-instructions, machine instructions, such as produced by a compiler, and files containing higher-level instructions that are executed by a computer using an interpreter. For example, an implementation may be implemented using Java™, C++, or other object-oriented programming language and development tools. Additional examples of computer code include, but are not limited to, control signals, encrypted code, and compressed code.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As a specific example, a signature used to authenticate a communications module can be a part of a larger certificate stored at the communications module that also includes the data set (or portions thereof) from which a digest is generated and encrypted to define the signature. Thus, for example, a certificate can include data values of registers used to generate a signature that is also included in the certificate. Furthermore, it should be understood that the systems and methods described herein can include various combinations and/or sub-combinations of the components and/or features of the different implementations described. Thus, features described with reference to one or more implementations can be combined with other implementations described herein.

What is claimed is:

1. A communications module, comprising:
a host interface;
a communications link interface;
a memory including a signature based on a data set and a private key of a key pair; and
a processor to provide the data set and the signature via the host interface, the processor operatively coupled to the host interface, to the communications link interface, and to the memory.

2. The communications module of claim 1, wherein:
the signature is a first signature;
the key pair is a first key pair;
the memory includes a second signature based on a public key of the first key pair and a private key of a second key pair; and
the processor is operable to provide the second signature via the host interface.

3. The communications module of claim 1, wherein:
the data set includes a data value of a first register and a data value of a second register, the first register and the second register accessible via the host interface.

4. The communications module of claim 1, wherein:
the host interface is an electrical interface; and
the communications link interface is an optical interface.

5. The communications module of claim 1, wherein the data set includes a unique identifier stored at the memory.

6. The communications module of claim 1, wherein the data set includes an identifier uniquely associated with the processor.

7. The communications module of claim 1, wherein the processor is operable to provide an identifier of a signer associated with the public key of the key pair via the host interface.

8. The communications module of claim 1, wherein the memory is integrated with the processor.

9. A communications module host, comprising:
a plurality of communications module interfaces; and
an authentication module operatively coupled to the plurality of communications module interfaces to provide an authentication request via each communications module interface from the plurality of communications module interfaces,
the authentication module configured to:
receive a signature via each communications module interface,
receive a data set via each communications module interface, and
authenticate a communications module operatively coupled to each communications module interface based on the data set and the signature received via that communications module interface,
the signature received via each communications module interface is based on the data set received via that communications module interface and a private key of a key pair.

10. The communications module host of claim 9, wherein:
the data set received via each communications module interface is uniquely associated with the communications module operatively coupled to that communications module interface; and
the key pair having the private key on which the signature received via each communications module interface is based is associated with the communications module operatively coupled to that communications module interface.

11. The communications module host of claim 9, wherein:
the plurality of communications module interfaces are hot-swappable communications module interfaces.

12. The communications module host of claim 9, wherein:
the signature received via each communications module interface is a first signature received via that communications module interface and the key pair having the private key on which the first signature received via that communications module interface is based is a first key pair; and
the authentication module is configured to receive a second signature via each communications module interface, the second signature received via each communications module interface based on a public key of the first key pair associated with the communications module operatively coupled to that communications module interface and a private key of a second key pair.

13. The communications module host of claim 9, wherein the authentication module is configured to:
determine that the communications module operatively coupled to a communications module interface from the plurality of communications module interfaces was not authenticated; and
disable communication with the communications module interface to which the communications module that was not authenticated in response to the determining.

14. A communications system, comprising:
a communications module host including a plurality of communications module interfaces; and
a plurality of communications modules, each communications module from the plurality of communications module removably coupled to a communications module interface from the plurality of communications module interfaces,
the communications module host operable to request a signature and a data set at each communications module via the communications module interface to which that communications module is removably coupled,
each communications module operable to provide the signature and the data set requested at that communications module to the communications module host, the signature provided from each communications module based on the data set requested at that communications module and a private key of a key pair associated with that communications module.

15. The communications system of claim 14, wherein:
the communications module host is operable to authenticate each communications module based on the data set and the signature received from that communications module.

16. The communications system of claim 14, wherein:
the communications module host is operable to determine that a communications module from the plurality of communications modules is not authentic based on the data set and the signature received from that communications module.

17. The communications system of claim 14, wherein the data set provided by each communications module is uniquely associated with that communications module.
